(19) United States
(12) Patent Application Publication
(10) Pub. No.: US 2021/0323628 A1
(43) Pub. Date: Oct. 21, 2021

(54) STEERING MECHANISM OF ALL-TERRAIN VEHICLE AND ALL-TERRAIN VEHICLE

(71) Applicant: SEGWAY TECHNOLOGY CO., LTD., Jiangsu (CN)

(72) Inventor: Xiang Li, Jiangsu (CN)

(21) Appl. No.: 17/232,212

(22) Filed: Apr. 16, 2021

(30) Foreign Application Priority Data
Apr. 16, 2020 (CN) 202020564526.3

(51) Int. Cl. B62K 5/08; B62K 5/01

(52) U.S. Cl. CPC B62K 5/08; B62K 5/01

(57) ABSTRACT

Embodiments of the present disclosure provide a steering mechanism of an all-terrain vehicle, including: a steering shaft; a power steering system; and a connecting portion including a first shaft sleeve, a second shaft sleeve and an elastic membrane assembly. The elastic membrane assembly includes at least one elastic membrane. The first shaft sleeve and the second shaft sleeve are arranged on two sides of the elastic membrane assembly and fastened to the elastic membrane assembly. An end of the first shaft sleeve away from the elastic membrane assembly is coupled to the steering shaft, and an end of the second shaft sleeve away from the elastic membrane assembly is coupled to the power steering system. Embodiments of the present disclosure further provide an all-terrain vehicle.

### CROSS-REFERENCE TO RELATED APPLICATION

This application is based on and claims priority to Chinese Application No. 202020564526.3, filed on Apr. 16, 2020, the entire contents of which are incorporated herein by reference for all purposes.

### FIELD

The present disclosure relates to the field of vehicle manufacturing, and more particularly, to a steering mechanism of an all-terrain vehicle and an all-terrain vehicle.

### BACKGROUND

In the related art, a steering shaft of an all-terrain vehicle is generally directly and rigidly coupled to a power steering system, but due to certain errors in manufacturing and assembling processes, there is a situation where the steering shaft is not coaxial with the power steering system, such that a steering wheel of the all-terrain vehicle will become heavy or difficult to turn in a long-term frequent steering process, which in turn causes parts for fixing the steering shaft to be easily worn, and ultimately affects driving safety.

### SUMMARY

An embodiment of the present disclosure provides a steering mechanism of an all-terrain vehicle, including: a steering shaft; a power steering system; and a connecting portion. The connecting portion includes a first shaft sleeve, a second shaft sleeve, and an elastic membrane assembly. The elastic membrane assembly includes at least one elastic membrane; the first shaft sleeve and the second shaft sleeve are arranged on two sides of the elastic membrane assembly and fastened to the elastic membrane assembly; an end of the first shaft sleeve away from the elastic membrane assembly is coupled to the steering shaft, and an end of the second shaft sleeve away from the elastic membrane assembly is coupled to the power steering system.

Another embodiment of the present disclosure further provides an all-terrain vehicle of a straddle type. The all-terrain vehicle includes a frame and a steering mechanism arranged to the frame. The steering mechanism includes a steering shaft; a power steering system; and a connecting portion including a first shaft sleeve, a second shaft sleeve, and an elastic membrane assembly. The elastic membrane assembly includes at least one elastic membrane; the first shaft sleeve and the second shaft sleeve are arranged on two sides of the elastic membrane assembly and fastened to the elastic membrane assembly; an end of the first shaft sleeve away from the elastic membrane assembly is coupled to the steering shaft, and an end of the second shaft sleeve away from the elastic membrane assembly is coupled to the power steering system.

Another embodiment of the present disclosure provides a steering mechanism of an all-terrain vehicle, including: a steering shaft; a power steering system; and a connecting portion. The connecting portion includes a shaft sleeve and an elastic membrane assembly. The elastic membrane assembly is coupled to the steering shaft and includes at least one elastic membrane. The shaft sleeve is arranged on a side of the elastic membrane assembly away from the steering shaft, and the shaft sleeve has a first end fastened to the elastic membrane assembly and a second end coupled to the power steering system.

### BRIEF DESCRIPTION OF THE DRAWINGS

FIG. 1 is a schematic structural diagram of a steering mechanism according to an embodiment of the present disclosure;

FIG. 2 is a schematic structural diagram of the steering mechanism shown in FIG. 1, from another angle of view;

FIG. 3 is a partial enlarged view at A in FIG. 2;

FIG. 4 is a schematic structural diagram of a connecting portion shown in FIG. 1;

FIG. 5 is a schematic structural diagram of the connecting portion shown in FIG. 4, from another angle of view;

FIG. 6 is a schematic structural diagram of the connecting portion shown in FIG. 4, from yet another angle of view; and

FIG. 7 is a schematic structural diagram of another connecting portion according to an embodiment of the present disclosure.

### DETAILED DESCRIPTION

It should be noted that embodiments and technical features in the embodiments of the present disclosure may be combined with each other without conflict, and detailed description shall be understood as explanation on principles of the present disclosure rather than construed as limitation of the present disclosure.

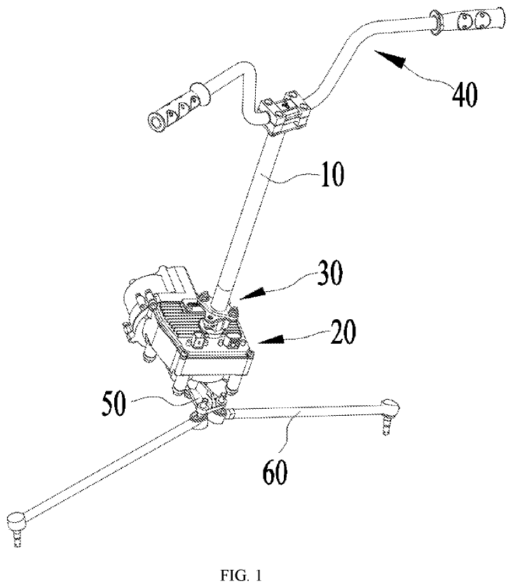

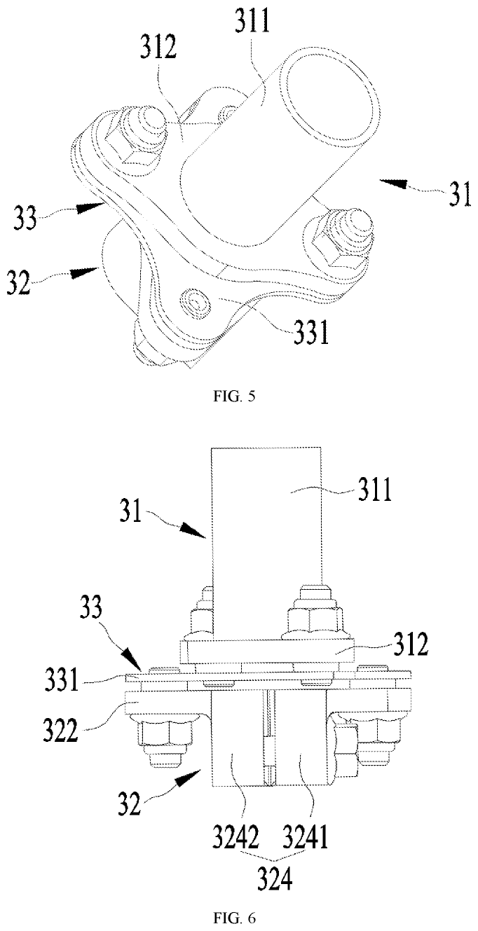

An embodiment of the present disclosure provides a steering mechanism of an all-terrain vehicle. Referring to FIGS. 1 to 6, the steering mechanism includes a steering shaft 10, a power steering system 20 and a connecting portion 30. The connecting portion 30 includes a first shaft sleeve 31, a second shaft sleeve 32 and an elastic membrane assembly 33, and the elastic membrane assembly 33 includes at least one elastic membrane 331. The first shaft sleeve 31 and the second shaft sleeve 32 are arranged on two sides of the elastic membrane assembly 33 and are both fastened to the elastic membrane assembly 33. An end of the first shaft sleeve 31 away from the elastic membrane assembly 33 is coupled to the steering shaft 10, and an end of the second shaft sleeve 32 away from the elastic membrane assembly 33 is coupled to the power steering system 20.

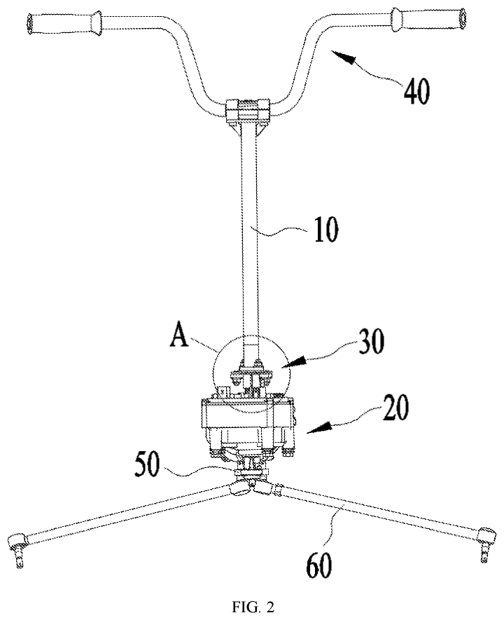

Specifically, referring to FIGS. 1 and 2, the steering mechanism according to the present embodiment further includes a steering handle assembly 40, a steering rocker arm 50, and two steering links 60. The steering handle assembly 40 is coupled to the steering shaft 10. The steering rocker arm 50 has a first end rotatably coupled to the power steering system 20 and a second end rotatably coupled to the two steering links 60. The steering links 60 are coupled to wheels of the all-terrain vehicle to steer the wheels during driving.

In order to make the first shaft sleeve 31 and the second shaft sleeve 32 fastened to the elastic membrane 331 conveniently, referring to FIGS. 4 to 6, the first shaft sleeve 31 in the present embodiment includes a first body 311 and a first connecting plate 312 arranged at one end of the first body 311; the second shaft sleeve 32 includes a second body 321 and a second connecting plate 322 arranged at one end of the second body 321. The first connecting plate 312 is fastened to the elastic membrane assembly 33, and the second connecting plate 322 is fastened to the elastic membrane assembly 33. It can be appreciated that the first connecting plate 312 and the second connecting plate 322 may be omitted in other embodiments, and for example, end surfaces of the first body 311 and the second body 321 may be fastened to the elastic membrane assembly 33.

The power steering system 20 according to the present embodiment is an electric power steering (EPS) system. The EPS system is a power steering system that relies directly on an electric motor to provide auxiliary torque directly. Compared with a hydraulic power steering (HPS) system, the EPS system can eliminate the need for power steering oil pumps, hoses, hydraulic oil, conveyor belts and engine-mounted pulleys that are necessary for the HPS system, thereby saving energy and protecting the environment. In addition, the EPS system also has the advantages of simple adjustment, flexible assembly and capability of providing steering power under various conditions. It can be understood that the power steering system 20 may also be an HPS system in other embodiments.

The elastic membrane 331 in the present embodiment has a certain elastic deformation capability. Axial, radial and angular offsets between the steering shaft 10 and the power steering system 20 caused by manufacturing and assembling errors can be compensated by the elastic deformation of the elastic membrane 331, thus avoiding a situation where a steering wheel of the all-terrain vehicle becomes heavy or difficult to turn in a long-term frequent steering process, preventing abrasion of parts for fixing the steering shaft 10, greatly improving controllability of an operator during driving, and guaranteeing driving safety. The elastic membrane 331 in the present embodiment is configured as a metal sheet, and more specifically, the metal sheet may be a stainless steel sheet. In other embodiments, the elastic membrane may be made of other materials as long as it has a certain elastic deformation capability. In the present embodiment, only one elastic membrane 331 is provided in the elastic membrane assembly 33 and fastened to both the first shaft sleeve 31 and the second shaft sleeve 32. In other embodiments, the elastic membrane assembly 33 may include a plurality of stacked elastic membranes 331.

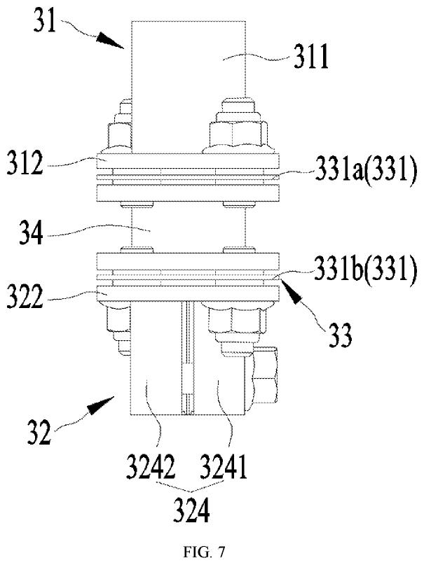

Further, referring to FIG. 7, in another embodiment, the elastic membrane assembly 33 may include two elastic membranes 331. For convenience of description, in the present embodiment, the two elastic membranes 331 are referred to as a first elastic membrane 331a and a second elastic membrane 331b, and the connecting portion 30 further includes a rigid spacer 34. The rigid spacer 34 is interposed between and fastened to the first elastic membrane 331a and the second elastic membrane 331b. The first shaft sleeve 31 is arranged on a side of the first elastic membrane 331a away from the rigid spacer 34, and fastened to the first elastic membrane 331a. The second shaft sleeve 32 is arranged on a side of the second elastic membrane 331b away from the rigid spacer 34, and fastened to the second elastic membrane 331b. By providing the rigid spacer 34 between the first elastic membrane 331a and the second elastic membrane 331b, the first shaft sleeve 31 and the second shaft sleeve 32 can be offset in different directions, thus compensating for eccentricity between the steering shaft 10 and the power steering system 20.

Referring to FIGS. 1 to 4, the power steering system 20 in the present embodiment is splined to the second shaft sleeve 32.

Specifically, the power steering system 20 in the present embodiment includes a connecting shaft 21 having an external spline 21a, and the second shaft sleeve 32 is provided with a shaft hole 32a having an internal spline 32b. The second shaft sleeve 32 is fitted over the connecting shaft 21, and the external spline 21a is fitted with the internal spline 32b. The splines have a high load-bearing capacity and good centering property, thus improving the reliability of connection between the power steering system 20 and the second shaft sleeve 32. In other embodiments, the connecting shaft 21 may be provided with an internal spline 32b, the second shaft sleeve 32 may be provided with an external spline 21a, and the connecting shaft 21 may be fitted over the second shaft sleeve 32.

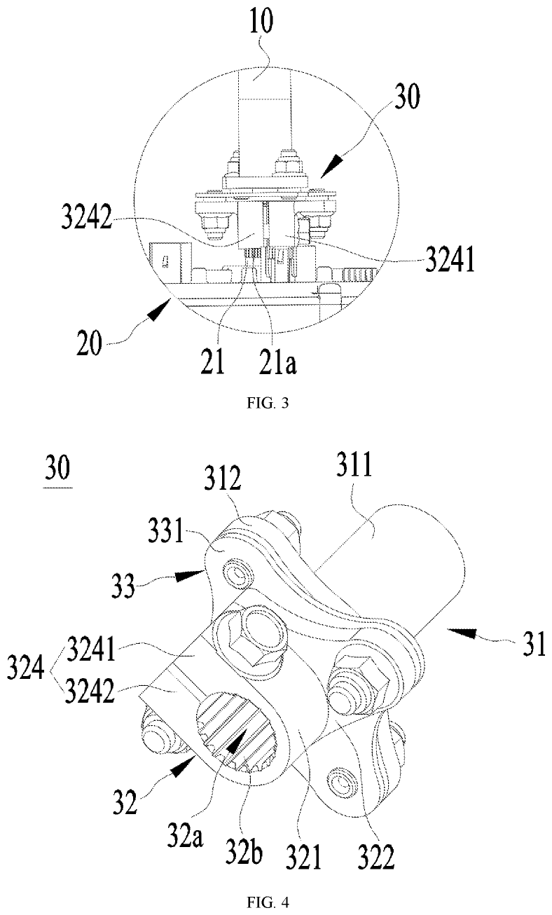

Further, referring to FIGS. 3, 4 and 6, the second shaft sleeve 32 in the present embodiment further includes a mounting portion 324 arranged on an outer wall of the second body 321. The mounting portion 324 includes a first mounting block 3241 and a second mounting block 3242 arranged oppositely, and a gap in communication with the shaft hole 32a is formed between the first mounting block 3241 and the second mounting block 3242. The second body 321 is fitted over the connecting shaft 21, and the first mounting block 3241 is fastened to the second mounting block 3242. By providing the mounting portion 324, the second shaft sleeve 32 can be mounted and dismounted conveniently. In other embodiments, the mounting portion 324 may be omitted. For example, a first through hole may be provided in a side wall of the second shaft sleeve 32, a second through hole may be provided in a side wall of the connecting shaft 21, and after the second shaft sleeve 32 is splined to the connecting shaft 21, the first through hole is in communication with the second through hole, and a fastener passes through the first through hole and the second through hole to fasten the second shaft sleeve 32 to the connecting shaft 21.

Additionally, in the present embodiment, the first shaft sleeve 31 is welded to the steering shaft 10, thus improving reliability of the connection between the first shaft sleeve 31 and the steering shaft 10. In other embodiments, the first shaft sleeve 31 may also be fastened to the steering shaft 10.

Another embodiment of the present disclosure further provides an all-terrain vehicle of a straddle type. The all-terrain vehicle includes a frame and the steering mechanism according to the above embodiment, and the steering mechanism is arranged to the frame.

The above description only involves some embodiments of the present disclosure and is not intended to limit the present disclosure, and various modifications and changes may be made to the present disclosure by those skilled in the art. Any modification, equivalent replacement, or improvement made within the principle of the present disclosure shall be included in the protection scope of the present disclosure.

What is claimed is:

1. A steering mechanism of an all-terrain vehicle, comprising:
a steering shaft;
a power steering system; and
a connecting portion comprising a first shaft sleeve, a second shaft sleeve, and an elastic membrane assembly,
wherein the elastic membrane assembly comprises at least one elastic membrane; the first shaft sleeve and the second shaft sleeve are arranged on two sides of the elastic membrane assembly and fastened to the elastic membrane assembly; an end of the first shaft sleeve away from the elastic membrane assembly is coupled to the steering shaft, and an end of the second shaft sleeve away from the elastic membrane assembly is coupled to the power steering system.

2. The steering mechanism according to claim 1, wherein the first shaft sleeve comprises a first body and a first connecting plate arranged at an end of the first body, and the second shaft sleeve comprises a second body and a second connecting plate arranged at an end of the second body; and
the first connecting plate is fastened to the elastic membrane assembly, and the second connecting plate is fastened to the elastic membrane assembly.

3. The steering mechanism according to claim 1, wherein the first shaft sleeve comprises a first body, and the second shaft sleeve comprises a second body; and
an end surface of the first body and an end surface of the second body are fastened to the elastic membrane assembly.

4. The steering mechanism according to claim 1, wherein the power steering system is splined to the second shaft sleeve.

5. The steering mechanism according to claim 4, wherein the power steering system comprises a connecting shaft having an external spline, the second shaft sleeve is provided with a shaft hole having an internal spline, and the internal spline is arranged on an inner wall of the shaft hole; and
the second shaft sleeve is fitted over the connecting shaft, and the external spline is fitted with the internal spline.

6. The steering mechanism according to claim 5, wherein the second shaft sleeve comprises a second body having the shaft hole, and a mounting portion arranged on an outer wall of the second body;
the mounting portion comprises a first mounting block and a second mounting block arranged oppositely, and a gap in communication with the shaft hole is formed between the first mounting block and the second mounting block; and
the second body is fitted over the connecting shaft, and the first mounting block is fastened to the second mounting block.

7. The steering mechanism according to claim 5, wherein a first through hole is provided in a side wall of the second shaft sleeve, a second through hole is provided in a side wall of the connecting shaft, and the first through hole is in communication with the second through hole.

8. The steering mechanism according to claim 1, wherein the elastic membrane assembly comprises two elastic membranes, the two elastic membranes are configured as a first elastic membrane and a second elastic membrane, and the connecting portion further comprises a rigid spacer;
the rigid spacer is interposed between and fastened to the first elastic membrane and the second elastic membrane;
the first shaft sleeve is arranged on a side of the first elastic membrane away from the rigid spacer, and fastened to the first elastic membrane; and
the second shaft sleeve is arranged on a side of the second elastic membrane away from the rigid spacer, and fastened to the second elastic membrane.

9. The steering mechanism according to claim 1, wherein the elastic membrane assembly comprises a plurality of stacked elastic membranes.

10. The steering mechanism according to claim 1, wherein the first shaft sleeve is welded to the steering shaft.

11. The steering mechanism according to claim 1, wherein the steering mechanism further comprises a steering rocker arm and two steering links; and
the steering rocker arm has a first end rotatably coupled to the power steering system and a second end rotatably coupled to the two steering links.

12. The steering mechanism according to claim 1, wherein the power steering system is an electric power steering system.

13. The steering mechanism according to claim 1, further comprising a steering handle assembly coupled to the steering shaft.

14. The steering mechanism according to claim 1, wherein the elastic membrane is a metal sheet.

15. An all-terrain vehicle of a straddle type, comprising:
a frame; and
a steering mechanism arranged to the frame, comprising:
a steering shaft;
a power steering system; and
a connecting portion comprising a first shaft sleeve, a second shaft sleeve, and an elastic membrane assembly,
wherein the elastic membrane assembly comprises at least one elastic membrane; the first shaft sleeve and the second shaft sleeve are arranged on two sides of the elastic membrane assembly and fastened to the elastic membrane assembly; an end of the first shaft sleeve away from the elastic membrane assembly is coupled to the steering shaft, and an end of the second shaft sleeve away from the elastic membrane assembly is coupled to the power steering system.

16. The all-terrain vehicle according to claim 15, wherein the first shaft sleeve comprises a first body and a first connecting plate arranged at an end of the first body, and the second shaft sleeve comprises a second body and a second connecting plate arranged at an end of the second body; and
the first connecting plate is fastened to the elastic membrane assembly, and the second connecting plate is fastened to the elastic membrane assembly.

17. The all-terrain vehicle according to claim 15, wherein the power steering system comprises a connecting shaft having an external spline, the second shaft sleeve is provided with a shaft hole having an internal spline, and the internal spline is arranged on an inner wall of the shaft hole; and
the second shaft sleeve is fitted over the connecting shaft, and the external spline is fitted with the internal spline.

18. The all-terrain vehicle according to claim 17, wherein the second shaft sleeve comprises a second body having the shaft hole, and a mounting portion arranged on an outer wall of the second body;
the mounting portion comprises a first mounting block and a second mounting block arranged oppositely, and a gap in communication with the shaft hole is formed between the first mounting block and the second mounting block; and
the second body is fitted over the connecting shaft, and the first mounting block is fastened to the second mounting block.

19. The all-terrain vehicle according to claim 15, wherein the elastic membrane assembly comprises two elastic membranes, the two elastic membranes are configured as a first elastic membrane and a second elastic membrane, and the connecting portion further comprises a rigid spacer;
the rigid spacer is interposed between and fastened to the first elastic membrane and the second elastic membrane;
the first shaft sleeve is arranged on a side of the first elastic membrane away from the rigid spacer, and fastened to the first elastic membrane; and
the second shaft sleeve is arranged on a side of the second elastic membrane away from the rigid spacer, and fastened to the second elastic membrane.

20. A steering mechanism of an all-terrain vehicle, comprising:
a steering shaft;
a power steering system; and
a connecting portion comprising a shaft sleeve and an elastic membrane assembly,
wherein the elastic membrane assembly is coupled to the steering shaft and comprises at least one elastic membrane; the shaft sleeve is arranged on a side of the elastic membrane assembly away from the steering shaft; and the shaft sleeve has a first end fastened to the elastic membrane assembly and a second end coupled to the power steering system.
